(19) United States
(12) Patent Application Publication
(10) Pub. No.: US 2017/0289208 A1
(43) Pub. Date: Oct. 5, 2017

(54) MONTAGE SERVICE FOR VIDEO CALLS

(71) Applicant: Microsoft Technology Licensing, LLC, Redmond, WA (US)

(72) Inventors: Alan Wesley Peevers, Palo Alto, CA (US); James Edgar Pycock, Palo Alto, CA (US)

(21) Appl. No.: 15/085,988

(22) Filed: Mar. 30, 2016

(51) Int. Cl. H04L 29/06; H04L 29/08

(52) U.S. Cl. CPC H04L 65/1083; H04L 65/60; H04L 67/10

(57) ABSTRACT

A montage service is disclosed herein that preserves moments of video calls for participants to revisit after the call. In an implementation, while a video call is ongoing the montage service identifies a set of candidate moments to consider for representation in a montage of the call. The service extracts content for each of the set of candidate moments from both of the video streams exchanged between the participant nodes and generates the montage from the extracted content after the call has ended. The montage may then be sent to one or more of the participant nodes on the call.

### TECHNICAL BACKGROUND

Video telephony services have become very popular as the capacity and capabilities of networks and communication devices alike have advanced. End users routinely engage in video calls in the context of business, social, and other interactions, and by way of a variety of communication platforms and technologies. Skype®, Skype® for Business, Google Hangouts® and Facetime® are just some examples of such services.

Most video calls employ bi-directional streams to carry video of the participants on a call. In one direction, for example, a video of the caller is carried upstream from the caller to the called party. In the other direction, video of the called party flows downstream to the caller. The video streams may flow through a mediation server or they may be exchanged directly between the participant nodes.

At the end of most calls, a record may be persisted in the call history of each participant. The call history may indicate, for example, when the call occurred, who it involved, and its duration. But other than those basic features, the end-user is left to his or her memory to recall what the call was about, even though it may have involved a cherished moment, an important exchange of information, a salient event, or the like.

As video calls continue to proliferate, more and more important moments will be lost. This will especially be the case in circumstances where loved ones or professional associates at a distance from each other interact much more routinely over video. Family gatherings, meetings, and other encounters will create moments that, if forgotten, will be a true loss for the participants that can't be replaced.

### OVERVIEW

A montage service is disclosed herein that preserves moments of video calls for participants to revisit after the call. In an implementation, while a video call is ongoing the montage service identifies a set of candidate moments to consider for representation in a montage of the call. The service extracts content for each of the set of candidate moments from both of the video streams exchanged between the participant nodes and generates the montage from the extracted content after the call has ended. The montage may then be sent to one or more of the participant nodes on the call. The service allows for the automatic capture of cherished moments, important information, and other moments that may occur when people engage with each other through video telephony services.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture in an implementation of a montage service.

FIG. 2 illustrates a montage process in an implementation.

FIGS. 3A-3C illustrate various operational scenarios in an implementation of montage technology for video calls.

FIG. 4 illustrates an operational architecture in an implementation of a montage service.

FIG. 5 illustrates an operational scenario in an implementation.

FIG. 6 illustrates an operational scenario in an implementation.

FIG. 7 illustrates an operational scenario in an implementation.

FIG. 8 illustrates an operational scenario in an implementation.

FIG. 9 illustrates a computing system suitable for implementing the montage service and associated technology disclosed herein, including any of the architectures, elements, processes, and operational scenarios and sequences illustrated in the Figures and discussed below in the Technical Disclosure.

### TECHNICAL DISCLOSURE

A montage service is disclosed herein that creates a digital artifact—or “montage”—at the end of a video call, to give one or more participants on the call something to remember the occasion and shared moments by. The montage may include a series of still images from the call, video clips, and/or audio clips that can be presented on a user's device in the context of their call history, a montage gallery, or any other viewing environment. The montage may be searchable, as well as sharable with others in the same manner as an image or video taken with a camera.

The montage service builds the montage during a call without user intervention or action. While the call is ongoing, the service evaluates the moments as they occur, whether or not they qualify as candidate moments. The evaluation may be based on rules that describe what moment may be suitable for inclusion in a montage, as well as what the overall profile of a montage should be.

In an example, the rules may specify that a montage include a fixed number of moments, no matter the duration of the call. The rules may also specify a percentage-based analysis that requires a certain percentage of the moments on a call to be included in the montage. A representative-based rule may also be possible, where the moments are selected to achieve a balanced representation of different types of moments. In yet another example, the rules may specify that the moments in the montage be spread evenly across the timeline of a call, weighted towards the beginning and ends of a call, or distributed across the timeline of the call in some other manner.

The rules may be applied as a call progresses in order to select candidate moments, but then re-applied at the end of a call to ensure that the best moments among the candidate moments are included in the montage. In some scenarios, the montage service becomes increasingly selective as a call progresses, so as to more quickly arrive at a final set for the montage at the end of the call.

The montage service may vary its rules based on the context of a given call. For example, the rule set for evaluating social calls may differ relative to those used to evaluate business calls. The rule set for evaluating moments between peers may differ from the rule set used to evaluate moments between people who occupy different positions in a hierarchy (e.g. parent-child or employer-employee). In addition, the resulting montage may differ for one participant versus another, even if the same rule set is utilized. The context of a call may be determined from caller profiles, a social graph, an enterprise graph, or other similar tools.

Various characteristics of or signals in the video may be considered when selecting an image, including technical qualities such as the lighting, focus, and resolution of the video of a moment. Other qualities include the emotive content of an image or clip as captured in a smile, expression, or action. A weighted approach of all of the qualities may be followed to ensure that high-quality moments are selected. For example, an image of a smiling person that is captured in low-light may be discarded in favor of a similarly-emotive image captured in adequate light.

A given moment may be drawn from just one of the media streams that make up a call. However, some moments may include content from both media streams on a bi-directional call, or more than two streams on a conference call. When content is drawn from two or more streams, the images or clips may coincide in time. However, non-coincident moments are also possible, where the content is drawn from non-coincident times in multiple media streams. For example, an action-reaction pair may be identified when one moment is a reaction to a preceding moment.

The montage service may be implemented “in the cloud,” and may run in-parallel with the communication service that supports the video calls between participants. However, the montage service could be implemented in a hybrid manner where some of its processing is in the cloud, but other loads are handled locally by the devices on a call. In another alternative, the montage service could be implemented in a peer-to-peer manner, which the moment selection and montage production handled by one or client devices.

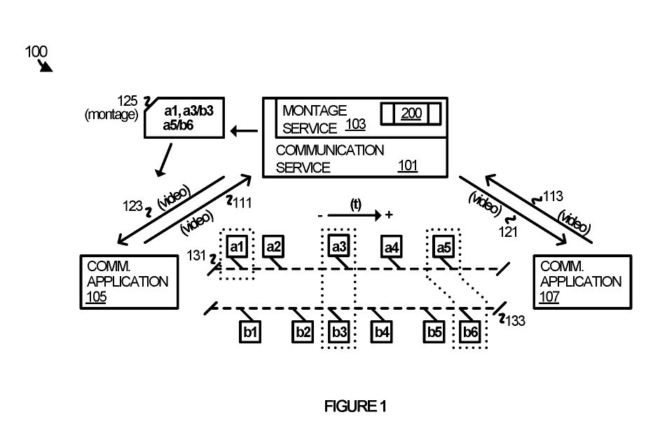

FIG. 1 illustrates an operational architecture 100 in an implementation of montages for video calls. Operational architecture 100 includes communication service 101 that provides a video telephony service to end points, represented by communication application 105 and communication application 107. Communication service 101 includes montage service 103 to produce montages for callers on the communication service.

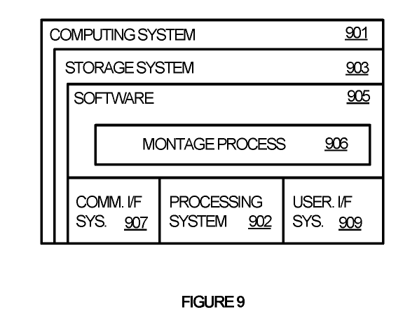

Communication service 101 is representative of any service or services capable of hosting video telephony session. Communication service 101 may be implemented using any computing system or systems, of which computing system 901 in FIG. 9 is representative. Montage service 103 may be implemented in the context of communication service 101 or as a separate service on the same or separate computing systems.

Communication application 105 and communication application 107 are each representative of a software client capable of engaging in a video call through communication service 101. The applications may be stand-alone applications or may be implemented in the context of another application. Communication applications 105 and 107 may be hosted on any suitable computing device, of which computing system 901 is representative.

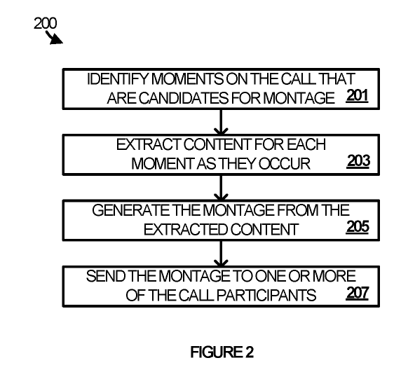

Montage service 103 employs montage process 200 to make montages of video call hosted by communication service 101. Montage process 200 may be implemented in the form of program instructions in the context of a software program, application, module, component, or a collection thereof. The following makes parenthetical reference to the steps illustrated in FIG. 2 with respect to montage process 200.

In operation, a video call is established between communication application 105 and communication application 107. The video call includes two streams: one originating from communication application 105 and another originating from communication application 107. In this example, the media streams transit communication service 101. Upstream segment 111 and downstream segment 121 carry the video captured by communication application 105, while upstream segment 113 and downstream segment 123 carry the video captured by communication application 107.

Montage service 103 monitors the media streams for moments of distinction to occur that might qualify as candidates for inclusion in a montage. Monitoring the video for moments may include, for example, monitoring facial expressions, motions, spoken words, vocal characteristics, and other artifacts of the content in the video that may indicate that a notable moment may have occurred.

Montage service 103 identifies candidate moments from the other moments occurring on the call (step 201). In some scenarios, a given moment may be assigned a score based on its particular characteristics and the score evaluated against a threshold. In another example, the characteristics of a moment may be evaluated against criteria and the moment designated as a candidate moment when the criteria is satisfied.

In this example, a timeline 131 illustrates the various moments occurring in the video originating with communication application 105 (moments a1-a6). Timeline 133 represents the moments occurring in the video originating with communication application 107 (moments b1-b6). Both timelines represent the moments as they occurred chronologically on the call, with the timelines progressing from left to right. Thus, moment a1 occurred prior to moment b1 and a2, while moment b1 occurred prior to moment a2.

Moment a1 is identified by montage service 103 as a candidate moment. In addition, moment pair a3/b3 and moment pair a5/b6 are identified as candidates. The moment pairs may be, for example, an action-reaction pair, a simultaneous pair, or some other pairing of moments. Thus, moments a3 and b3 may be simultaneous actions or events that may be grouped together as a single moment (and thus presented together in the montage as a single moment. Likewise, moment a5 and moment b6 may be presented together in the montage as a single moment.

Montage service 103 extracts the content for each candidate moment as the moment occurs (step 203). This is accomplished by retaining the portion of the video that was analyze din order to categorize a given moment as a candidate for the montage, while discarding the portion(s) of the video related to non-candidate moments. In this manner, content extraction may occur on-the-fly, so as to obviate the need for recording. Some limited recording or buffering may occur in order to allow montage service 103 to analyze the video for candidate moments, but in general, content extraction only occurs for the candidate moments.

Having identified the candidate moments, montage service 103 generates the montage from the extracted content (step 205). The montage may be created from the content extracted for one or more of the candidate moments. In some case, all of the candidate moments are used to create the montage, with no further filtering of candidate moments. In other cases, additional filtering may be performed to identify an even more select subset of moments to put in the montage.

Montage service 103 may send the montage to one or more of the participant nodes (step 207). In this scenario, the montage 125 resulting from the montage process includes clips, images, audio, or other artifacts for moment a1, moments a3 and b3 (presented as a moment pair), and moments a5 and a6 (presented as another moment pair). Montage 125 may be sent to communication application 105 to be surfaced in a user interface to the application or to any other application or view. Montage 125 may optionally be sent to both participant nodes. In some case, the montage may vary for each participant. For example, the montage created from the caller may differ from the montage created for the called party in terms of what moments are selected, which moments are emphasized, and the like.

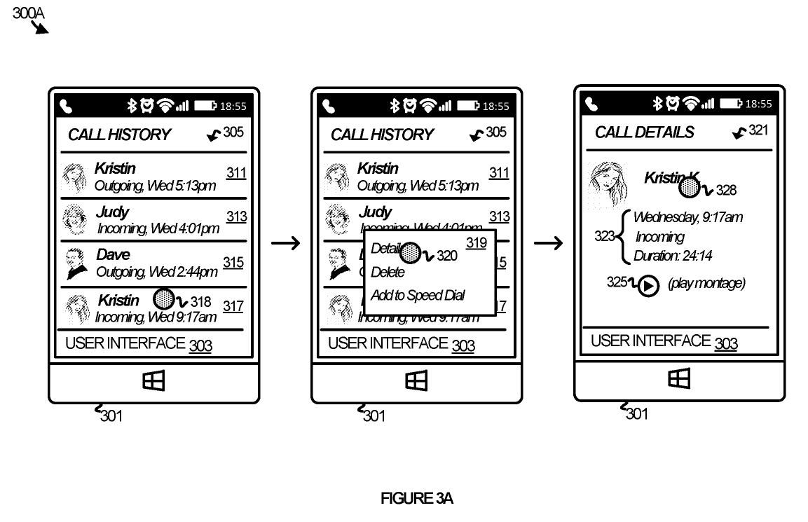

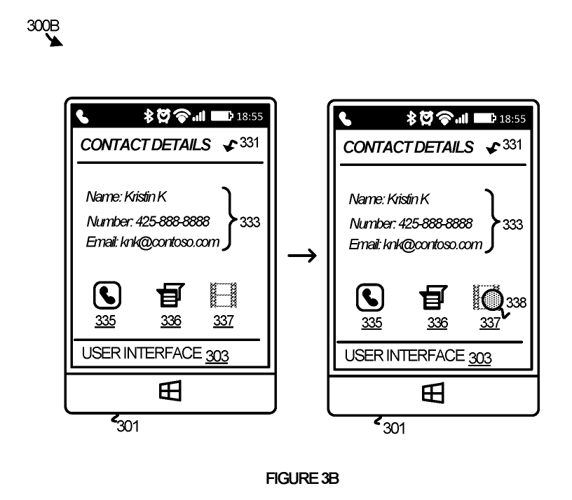

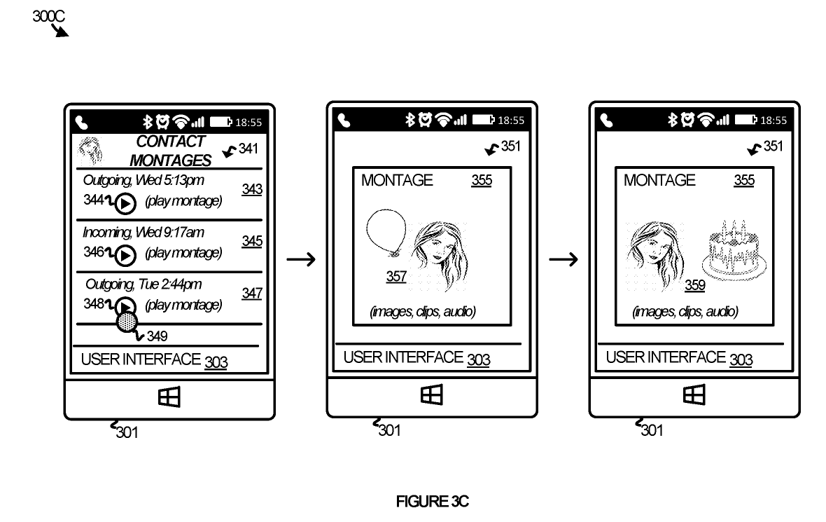

FIGS. 3A-3C illustrate various operational scenarios in an implementation of montage technology. Operational scenario 300A in FIG. 3A involves communication device 301, which is representative of a mobile phone, tablet, or other such device suitable for hosting a video call.

Communication device 301 loads and executes a communication application that renders a user interface 303 to the application. User interface 303 is initially populated with a view 305 of a call history. The view 305 of the call history includes various records of past incoming and outgoing call, represented by call record 311, call record 313, call record 315, and call record 317. The calls represented in the call history may be video calls, voice-only calls, or a combination of the two.

Each call record identifies various details of the call, so that a user may be reminded at a minimum what a given call was about. For example, call record 311 relates to an outgoing call to Kristin on Wednesday at 5:13 pm, while call record 313 relates to an incoming call from Judy on Wednesday at 4:01 pm. It may be assumed for exemplary purposes that each of the calls was a video call for which a montage was created by a montage service and downloaded to communication device 301, either when it is completed or in real-time when it is being played out.

A user may interact with the call records in view 305 in a variety of ways that are well known with respect to phone calling applications and call histories. For instance, a call record could be single-tapped to launch a new call to the contact. In another example, a long touch may surface a menu with additional options for interacting with a call record. Indeed, in this scenario a user input 318 is received by communication device 301 which triggers the rendering of menu 319. Menu 319 includes a details option for viewing additional details of the call, a delete option for deleting the call record, and an add-to-speed dial option for adding the contact to another view or user interface to allow for speed dialing.

Another user input, represented by user input 320, is received by the communication device 301, which navigates the user to a call detail view of the call record, represented in view 321. View 321 provides more detailed information on a given call, such as the time it occurred and whether it was incoming or outgoing, but also its duration (twenty-four minutes, in this example) and a montage of the call. Icon 325 is an element in user interface 303 that a user can select in order to play-out the montage. The montage may include various video clips, still images, and other information extracted from the video call while it was ongoing. Thus, the user may quickly view the montage in the context of examining the call details for a given call.

User interface 303 may transition to a detailed view of a contact, were the user to touch, click-on, or otherwise select a contact in view 305 or view 321. Indeed, a selection 328 of the contact for “Kristin” in view 321 transitions user interface 303 to view 331, illustrated in FIG. 3B in the context of operational scenario 300B. It may be appreciated that a user may navigate to or otherwise encounter view 331 by way of other views and/or other operational scenarios.

View 331 provides detailed information on a particular contact. In this case, view 331 provides detailed information 333 on Kristin, including her full name, her phone number, and her email address. View 331 also includes a set of command icons for interacting with the contact through one or more communication modalities, including an icon 335 for launching a phone call, an icon 336 for sending a text message, and an icon 337 for viewing other montages associated with the contact. A selection 338 navigates the user to a view 341 of montages for the contact, illustrated in FIG. 3C with respect to operational scenario 300C.

View 341 includes a list of montage records for a given contact, including montage record 343, montage record 345, and montage record 347. Each montage record corresponds to a different montage of video call and was generated by a montage service. The montage may be downloaded to communication device 301 in real-time when a user selects a montage to be played out. In other cases, the montage may be downloaded at the end of the call it corresponds to, after having been produced by the montage service.

Each montage record includes some information about the corresponding call, such as when it occurred and whether it was an incoming call or an outgoing call. The montage records 343, 345, and 347 also each include a play button for playing out a corresponding montage, represented by play buttons 344, 346, and 348 respectively. While the play buttons are used in view 341 to launch a montage, other techniques are possible and the play buttons are only optional. For example, just touching, clicking-on, or selecting a montage record may cause its corresponding montage to play.

A selection 349 of play button 348 results in the playing out of montage 355 in view 351. The montage 355 may include, for example, video clips, images, audio, and other content. Montage 355 allows the user to be quickly reminded about the important moments on the call memorialized by the montage.

A moment 357 is illustrated in montage 355 initially and is representative of a moment that may be captured in montage. Moment 357 includes an image of the contact on the call that includes a background item (e.g., a balloon). The images may have been captured in a frame or video clip extracted by the moment service for inclusion in the montage 355. A subsequent moment 359 is also shown in montage 355. The subsequent moment 359 would presumably be displayed after the preceding moment, moment 357, as montage 355 is played out. Moment 359 includes another image of the contact and another object that may be been presented on the call (e.g., a birthday cake). Thus, in this limited example, the montage 355 captures at least two moments on the call—the presentation of a balloon and the presentation of a birthday cake. The montage 355 will allow the end-user to be quickly reminded of the content of the video call.

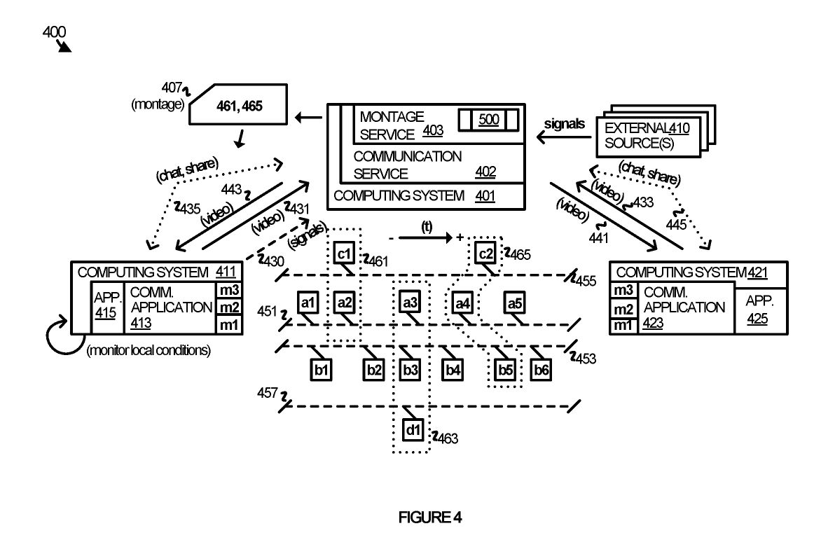

FIG. 4 illustrates another operational architecture 400 in an implementation of montage technology. Operational architecture 400 includes a communication service 402 hosted on computing system 401. Communication service 402 is representative of any video calling service (sometimes referred to as a video conferencing or video chatting service) capable of supporting video calls between participant nodes. Communication service 402 may be implemented on a wide variety of computing and communication systems, of which computing system 401 is representative. In some scenarios, communication service 402 is implemented in a data center, a telecommunication facility, or in some other suitable environment. Skype®, Hangouts®, and FaceTime® are some examples of communication service 402, although many other types of video calling services and platforms are possible and may be considered within the scope of the present disclosure.

Communication service 402 provides video conferencing capabilities that allow end-users to communicate via a variety of modalities. Communication application 413 and communication application 423, implemented on computing system 411 and computing system 421 respectively, interface with communication service 402 in order to support such modalities. Communication applications 413 and 423 in this implementation support at least three modalities, including video, chat, and desktop sharing. Application 415 and application 425 are representative of other applications that may be considered external to communication applications 413 and 423.

Communication service 402 includes a montage service 403 that produces montages of calls for call participants to consume. Montage service 403 may run in the context of communication service 402 or may be a stand-alone service offered separately from communication service 402 (even by a third party in some scenarios).

In operational architecture 400, a video call has been established between communication application 413 and communication application 423. Video originating from communication application 413 is represented by media stream 431 and media stream 441, while video originating from communication application 423 is represented by media stream 433 and media stream 443. The call participants may exchange other communications in addition to the video, such as chat messages or their desktops, represented by media link 435 and media link 445.

Communication service 402 serves as a transit hub through which video, chat messages, and other items exchanged between participant nodes may flow. Such an arrangement allows montage service 403 to analyze the video for key moments. In an alternative arrangement, the participant nodes could exchange video directly with each other, while providing a copy of the video to montage service 403. In still another alternatively, the participant nodes could send meta data to montage service 403 that would be descriptive of the video being exchanged, rather than sending the actual video.

In some implementations, the participant nodes may supplement the analysis provided by montage service 403 and supply signals 430 to montage service 403 indicative of local operating conditions that may signify an important moment on a call. For instance, communication application 413 (and/or communication application 423) may monitor the local acceleration profile of computing system 411 for when a sudden movement occurs, when motion occurs (such as when a user turns a device to point it at something interesting), or other local characteristics. Communication application 413 can report those occurrences in signals 430 to montage service 403, such that montage service 403 is assisted in identifying candidate moments.

In another example, communication application 413 (and/or communication application 423) may supply higher-quality video for a period of time surrounding a candidate moment to montage service 403. In normal operation, the upstream video feeds provided by the communication applications to communication service 402 are of a lower quality than what is actually captured by the underlying computing devices. A high-definition video may be captured locally, for instance, but a mid-quality of low-quality video sent up to the communication service for routing to a recipient node. When montage service 403 identifies a candidate moment, it may request a high-definition version of the video for the moment. In other situations, the communication application may pro-actively send high-definition video for moments that it anticipates may be candidate moments (e.g. by virtue of a local characteristic).

Operational architecture 400 also include an external source 410 (or sources) of signaling to montage service 403. External source 410 is optional, but may provide another supplement to montage service 403 when monitoring video calls for candidate moments. Examples of external source 410 include, but are not limited to, office graphs, social graphs, email systems, document storage systems, music and/or movie services, and other platforms, services, and technologies that might be considered separate from communication service 402. The external signals may identify other activities that are occurring in parallel with a video call, but that would otherwise be out of the monitoring scope of montage service 403. The other activities can be noted by montage service 403 and possibly incorporated into a montage (if relevant). In other scenarios, the signaling supplements what montage service 403 is discovering independently, improving the selection capabilities of the service and making montages more relevant to end-users.

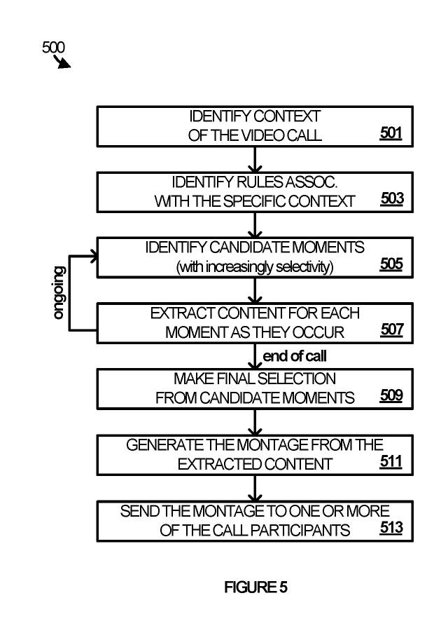

Montage service 403 employs montage process 500 to make montages of video call hosted by communication service 402. Montage process 500 may be implemented in the form of program instructions in the context of a software program, application, module, component, or a collection thereof. The following makes parenthetical reference to the steps illustrated in FIG. 5 with respect to montage process 500.

As mentioned above, a video call is established between communication application 413 and communication application 423. The applications support various communication modalities, including video, chat t, and desktop content sharing (m1, m2, and m3). Thus, the participants on the call may exchange chat messages, pictures, and other content in addition to their interaction over the video.

Montage service 403 monitors the media streams, chat messages, and external signals for moments of distinction to occur that might qualify as candidates for inclusion in a montage. Monitoring the video for moments may include, for example, monitoring facial expressions, motions, spoken words, vocal characteristics, and other artifacts of the content in the video that may indicate that a notable moment may have occurred. Monitoring the chat messages may include analyzing the words and phrases in the text for notable moments. The frequency of messages, expressions included in the messages, and other characteristics of the messages may also be indicative of their importance.

In operation, montage service 403 identifies a context of the call (step 501). For instance, montage service 403 attempts to determine whether the call is a call between friends or family or a business call social call. Within such categories, montage service 403 may also attempt to determine the sub-context of the call, such as whether the call is between peers or individuals in a hierarchical relationship (e.g. parent-child, employer-employee).

Different rules for different contexts may be employed by montage service 403 when building a montage of a call. As the montage may differ between participants, the rules may also vary at a per-participant level. Thus, having identified the context of a call, montage service 403 identifies a specific rule set to use when evaluating moments in a call for inclusion in a montage (step 503).

All of the moments identified by montage service 403 are illustrated in the timelines in FIG. 4, including timeline 451, timeline 453, timeline 455, and timeline 457. Each timeline includes representations of the various moments that were identified by montage service 403 during the call for each modality, progressing in time from left to right in time. Timeline 451 represents the moments occurring in the video stream originating from communication application 413 (moments a1-a5). Timeline 453 represents the moments occurring in the video stream originating from communication application 423 (moments b1-b6). Timeline 455 represents the moments occurring in the other non-video modalities, such as chat and desktop sharing (moments c1-c2). Lastly, timeline 457 represents moments that may occur external to communication applications 413 and 423, such as those reported by external source 410 (moment d1).

As moments are continuously occurring on the call, montage service 403 applies the rules to identify the moments that qualify as candidate moments—those to consider for inclusion in a montage (step 505). The candidate moments include candidate moment 461, candidate moment 463, and candidate moment 465. The candidate moments in this example include multiple individual moments. Candidate moment 461 includes moments a2 and c1, for instance, while candidate moment 463 includes moments a3, b3, and d1. Candidate moment 465 includes moments c2, a4, and b5.

Some words may be more indicative of a candidate moment than others, such as “amazing,” “wonderful”, “crucial,” and “critical.” Facial expressions can be detected and may also be indicative of a candidate moment, such as smiles and looks of surprise. Emotion and other affections may also be detected, as well as the rate of speech, rate of “turn taking,” pitch and stress indicators.

In some implementations, various metrics related to the integrity of the video being captured may factor into the selection process. For instance, intervals of video with high quality video (good lighting, good contrast, etc.) may be better candidates than others. Intervals with poor lighting or poor contrast can be discarded. Intervals where the camera is steady may be also be better candidates, whereas intervals that are blurry or that include a fast-moving camera may be discarded.

Other metrics that may be considered when retaining or discarding moments include the channel bandwidth of a particular segment or the quantization parameter (QP) for a given segment. Events that occur and that are detected may also impact the selection of candidate moments. Some example events include when a new object enters a scene and when a scene changes as indicated by camera zooms or transitions from the main camera to a supplemental camera.

As candidate moments are identified, montage service 403 extracts content associated with the moments for later inclusion (potentially) in the montage (step 507). Montage service 403 continues to analyze moments as they occur for inclusion in the montage, but with increasing selectiveness as the call progresses. The selectiveness of montage service 403 may be increased by increasing thresholds expressed in the rules as the call progress or narrowing the criteria expressed in the rules.

Once a call ends, montage service 403 makes a final evaluation of the candidate moments to determine which subset to include in the montage (step 509). The final evaluation allows montage service 403 to reconsider some of the earlier moments in the call that were nominated as candidates when the selection criteria or thresholds were less selective than at the end of the call. This may enhance the relevance or meaningfulness of the moments in the resulting montage, especially for longer calls.

In some implementations, the attributes of the candidate moments may be used to create candidate scores for each moment. The scores can be used as an input when evaluating the candidate scores at the end of a call. A score may be calculated from the weighted sum of each of the attributes. The weighting may be varied depending upon the context of the call, the duration of the call, the proximity of a moment to a similar moment, and so on. For instance, a moment that is proximate in time to another very similar moment may be discarded or decremented in order to avoid having very similar moments in a montage. Dynamic evaluation techniques may be applied to balance out the distribution of moments, the quality of moments, and other aesthetic considerations.

The montage is then generated from the content that had been extracted from the call for the candidate moments (step 511) and the montage may be communicated to one or more of the participant nodes on the call. It is assumed for exemplary purposes that the resulting montage, montage 407, includes two candidate moments—candidate moment 461 and candidate moment 465. Montage service 403 may send the montage 407 to communication application 413, communication application 423, or both (step 513). The montage 407 may be sent immediately after it is generated after the call, or at a later time when a user navigates to a view in which the montage may be surfaced.

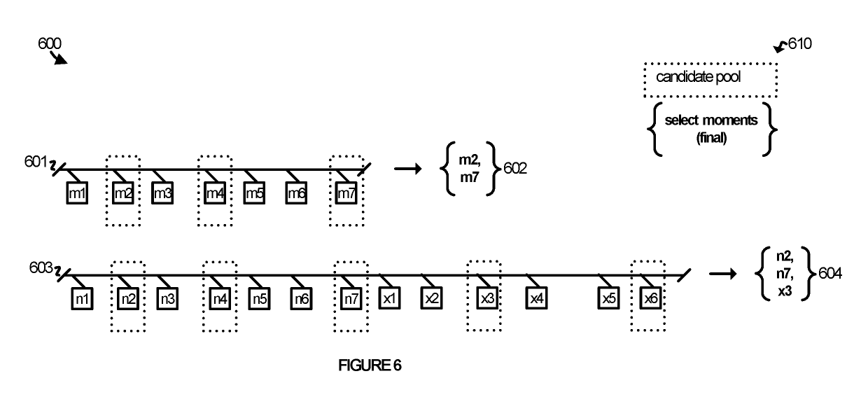

FIG. 6 illustrates a comparison 600 of two timelines for two different calls having similar (or the same) profiles, but different durations. Comparison 600 illustrates how the duration of a call affects the selectivity of a montage service as the call extends in duration. In particular, comparison 600 includes timeline 601 and timeline 603.

Timeline 601 represents the moments occurring on a call from left to right (moments m1-m8). The moments are evenly spaced out for exemplary purposes, although it may be appreciated that the moments on a given call are likely to occur at random or at least in a less orderly manner.

The candidate moments identified by a montage service in timeline 601 include moment m2, moment m4, and moment m7. The candidate moments are selected based on a rule set applied by the montage service and selected based on a context of a call. A final selection from the candidate moments is made at the end of the call by the montage service and includes moment m2 and moment m7. Thus, moment m4 is excluded from the final set, even though it qualified as a candidate moment.

Timeline 603 represents the profile of a call similar to the call described by timeline 601 for at least the first half of the call. However, the second call extends in duration for about twice as long as the first call. The moments identified in timeline 603 include moments n1-n7 (which correspond to moments m1-m7 in timeline 601) and moments x1-x6, which represent the moments occurring in the second half of the call.

The montage service selects moments n2, n4, and n7 as candidate moments, which may be expected under the assumptions that the two calls are very similar, the same rule set is applied, and the same level of selectivity is applied to moments m1-m7 as is applied to moments n1-n7. However, the level of selectively diverges during the second half of the call represented in timeline 603. During the second half of the call, only two of the six possible moments are nominated as candidate moments (x3 and x6). This represents how the montage service becomes increasingly selective as a call extends in duration. The final set selected from the candidate moments includes moments n2, n7, and x3.

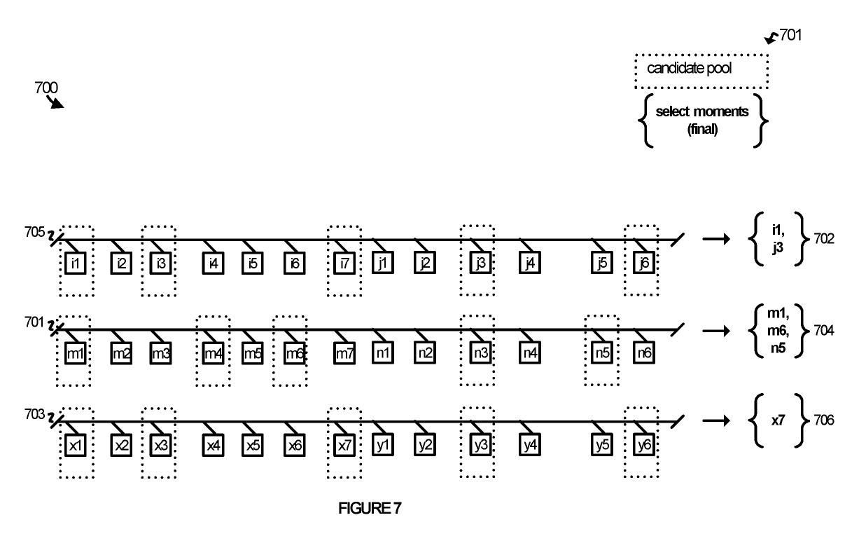

FIG. 7 illustrates another comparison 700 of various call timelines to demonstrate differing rule sets for similar calls results in different montages. Comparison 700 involves timeline 701, timeline 703, and timeline 705. Each timeline relates to a different call, but all of the calls have similar profiles. For example, the call represented in timeline 701 includes moments i1-i7 and j1-j6; the call represented in timeline 703 includes moments m1-m7 and n1-n6; and the call represented in timeline 705 includes moments x1-x7 and y1-y6. It may be assumed that each moment in a call is similar to its corresponding moment in the other two calls. For example, moment i1 corresponds to moments m1 and x1, moment j1 corresponds to moment n1 and y1, and so on for the remaining moments.

Accordingly, if the same rule set were to be applied by a montage service to the moments in each call, the set of candidates for a given call would be the same as the set of candidates for the other calls. In addition, the final set of moments in the montage would be the same for all of the calls.

However, the context of each call may differ from the context of the other calls. One call may be a social call between friends, while another may be a business call between an employer and an employee, while another may be a call between two peers who communicate frequently with each other. Thus, the rule set applied by the montage service to identify candidate moments and to select final moment may differ.

The result includes different candidate sets and differing final sets across all three calls. The candidate set in timeline 701 includes moments i1, i3, i7 and j3 and the final montage includes only moments i1 and j3. The candidate set in timeline 703 includes moments m1, m4, m6, n3, and n5, while the final montage includes only moments m1, m6, and n5. The candidate set in timeline 703 includes moments x1, x3, x7, y3, and y6, while the final montage includes only moment x7.

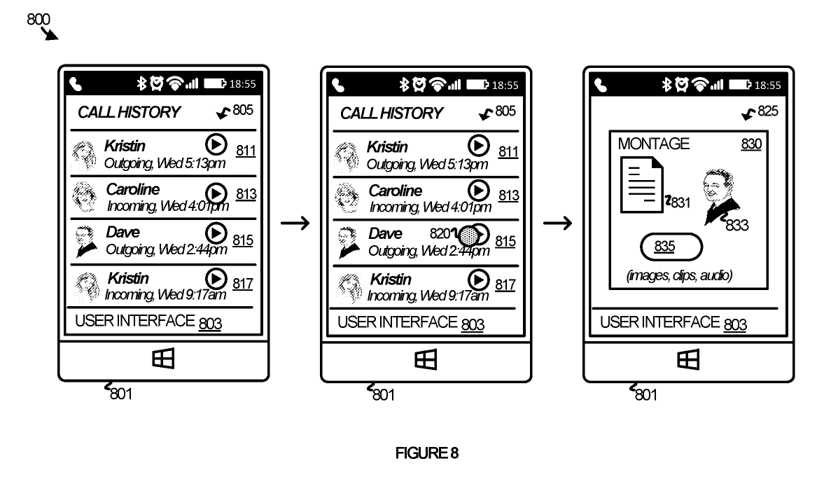

FIG. 8 illustrates a final example of how a user may navigate to a montage. In operational scenario 800, a computing system 801 renders a user interface 803 to a calling application. The user interface 803 includes a view 805 of a call history for the user. The call history includes various records for incoming and outgoing calls. For example, view 805 includes record 811, record 813, record 815, and record 817.

Each record includes some detailed information on a given call, the name of the party on the call, and a play button for playing out a montage of the call. A user may select a montage to play out by touching, clicking on, or otherwise selecting the play button. For example, user input 820 results in the montage 830 for record 813 playing out in view 825. Montage 830 includes an image of a person captured in the video, a document 831 that may have been exchanged between the participants during the call, and a chat message 835 that may also have been exchanged during the call.

It may be appreciated from the discussion above that a montage may be composed of frames and clips gathered during a call and chosen by a montage service to reflect the best moments of the call. Certain composition rules and guidelines employed by the service ensure that a good artefact is produced (such as one not having too many images). In addition to these general rules for composing an artefact, the service may also consider the nature of specific moments within a call and how such moments can influence the composition of the artefact. An example would be choosing to capture and include both one participant's action and another participant's reaction. By understanding that these are connected in one social moment, a rule may define them as a single moment.

Beyond this, the service may be capable of applying a range of composition styles. A particular style can be selected and applied to a given moment based on the nature of the moment or surrounding moments and the relationships between the selected images and clips in the moment(s). For example, images which are taken at different times during a call and which have no social or conversational relationship to each other might be composed into an artefact using slow fade transitions between one image and the next. Images that are connected to each other (for example as action-reaction) might be composed as rapid fire switching between one image and the next (for example showing the reaction of multiple participants in a group call).

Selection and composition of images into a montage could, for example, be triggered by a recognized keyword (e.g. “Awesome!”) which results in the system capturing a burst of photos or a slow motion video clip. Digital effects may be applied, such as color tint, contrast adjustments, and the like. A montage may be composed using a range of such styles within the montage, including slow cross fades for those unrelated images and a rapid fire sequence for connected moments.

The montage service may also be capable of understanding the different types of social and conversational moments and applying that understanding to the inclusion, selection, and mixing of audio as well. An example, the montage service would capture the audio for an action from one participant and then the audio reaction of the other participant (but perhaps no audio when images are unconnected). Another example would be for the service to mix the audio (e.g. from the participant making the action by delivering a ‘punchline’) on top of the video of another participant (e.g. the participant making the reaction—the ‘surprise’ moment). Additional audio effects could even be added beyond the captured words of participants (e.g. drum roll).

In some implementations, the montage service may be capable of dynamically changing the heuristics and criteria used to select images and clips during a call, to suit different product variations. The heuristics and criteria may also be changed for different types of calls and participants as the call is established. For example, the system may change the heuristics based on whether the call is one-to-one call or a group call, what the calling history is between the participants (e.g. is this a rare call or a daily call), what the time of day is, what the respective locations of the participants are, and other signals that the service obtains in order to infer what type of montage would be best for a given call.

It may also be appreciated that a montage service can make adjustments to heuristics during a call. For example, if the service detects that participants on a call are in a bad or aggressive mode, or that sad news was being conveyed on the call, then the service could adjust its rules to ensure that an appropriate montage is assembled.

In some implementations, an end-user may be able to edit a montage after a call. For instance, the end-user may be able to expand or contract the length of a moment within a montage, delete moments, or possibly add moments (if the absent moments are retained by the montage service). A film strip representation of the montage may allow call participants to delete individual images that they don't like.

The montage service may learn from this manual editing if a participant makes changes. The service could consider such edits as feedback on what a participant prefers in a montage, i.e. what constitutes good moments/memories. A particular participant might, for example, very rarely like pictures of themselves. The service could save this preference information for an individual participant and take it into account when creating montages for future calls (both future calls with the same participants and generally across calls).

FIG. 9 illustrates computing system 901, which is representative of any system or collection of systems in which the various applications, services, scenarios, and processes disclosed herein may be implemented. Examples of computing system 901 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes montage process 906 which is representative of the processes discussed with respect to the preceding FIGS. 1-8, including montage process 200 and 500. When executed by processing system 902 to enhance the video call experience, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device, but may also be distributed across multiple processing devices or sub-systems that cooperate in executing program instructions. Examples of processing system 902 include general purpose central processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device, but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. For example, software 905 may include program instructions for implementing a montage service (e.g. 103 and 403).

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtual machine software, or other application software, in addition to or that include montage process 906. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to enhance licensing operations. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 902 in support of the various user input and output devices discussed above. Separately or in conjunction with each other and other hardware and software elements, the user interface software and user interface devices may support a graphical user interface, a natural user interface, or any other type of user interface.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), AJAX (Asynchronous JavaScript and XML), H.323, H.264, RTP (real-time transport protocol), SIP (session initiation protocol), WebRTC, as well as any other suitable protocol, variation, or combination thereof.

Certain inventive aspects may be appreciated from the foregoing disclosure, of which the following are various examples.

### Example 1

A computing apparatus comprising: one or more computer readable storage media; a processing system operatively coupled with the one or more computer readable storage media and; a montage service comprising program instructions stored on the one or more computer readable storage media that, when read and executed by the processing system, direct the processing system to at least: while a video call is ongoing that comprises video streams exchanged between at least two participant nodes, identify a set of candidate moments to consider for representation in a montage of the video call and extract content for each of the set of candidate moments from both of the video streams; generate the montage from at least the content extracted from the video call for the set of candidate moments; and send the montage to at least one of the participant nodes.

### Example 2

The computing apparatus of Example 1 wherein the program instructions further direct the processing system to, after the video call has ended, select a subset of candidate moments from the set of candidate moments to represent in the montage, and wherein, to generate the montage for the set of candidate moments, the program instructions direct the processing system to generate the montage from the content extracted from the video call for each of the subset of candidate moments.

### Example 3

The computing apparatus of Examples 1-2 wherein the content extracted from both of the video streams for each of the candidate moments comprises an image or a clip of an action extracted from one of the video streams and another image or another clip of a reaction to the action extracted from another one of the video streams.

### Example 4

The computing apparatus of Examples 1-3 wherein the program instructions direct the processing system to, for at least one candidate moment of the set of candidate moments, identify external content from a source that is external to the video call, and include the external content in the montage.

### Example 5

The computing apparatus of Examples 1-4 wherein each of the video streams originates from a video modality in a communication application on a respective one of the participant nodes, wherein the source that is external to the video call comprises a modality other than the video modality in the communication application.

### Example 6

The computing apparatus of Examples 1-5 wherein each of the video streams originates from a video modality in a communication application on a respective one of the participant nodes, wherein the source that is external to the video call comprises an application other than the communication application.

### Example 7

The computing apparatus of Examples 1-6 wherein, to identify the set of candidate moments, the program instructions direct the processing system to evaluate moments occurring on the video call based on rules that become increasingly selective as the video call extends in duration.

### Example 8

The computing apparatus of Examples 1-7 wherein the program instructions direct the processing system to select the rules based on a context of the video call.

### Example 9

A method of operating a montage service comprising: while a video call is ongoing that comprises video streams exchanged between at least two participant nodes, identifying a set of candidate moments to consider for representation in a montage of the video call and extracting content for each of the set of candidate moments from both of the video streams; generating the montage from at least the content extracted from the video call for the set of candidate moments; and sending the montage to at least one of the participant nodes.

### Example 10

The method of Example 9 further comprising: after the video call has ended, selecting a subset of candidate moments from the set of candidate moments to represent in the montage; and wherein generating the montage for the set of candidate moments comprises generating the montage from the content extracted from the video call for each of the subset of candidate moments.

### Example 11

The method of Examples 9-10 wherein the content extracted from both of the video streams for each of the candidate moments comprises an image or a clip of an action extracted from one of the video streams and another image or another clip of a reaction to the action extracted from another one of the video streams.

### Example 12

The method of Examples 9-11 wherein the method further comprises, for at least one candidate moment of the set of candidate moments, identifying external content from a source that is external to the video call, and including the external content in the montage.

### Example 13

The method of Examples 9-12 wherein each of the video streams originates from a video modality in a communication application on a respective one of the participant nodes, wherein the source that is external to the video call comprises a modality other than the video modality in the communication application.

### Example 14

The method of Examples 9-13 wherein each of the video streams originates from a video modality in a communication application on a respective one of the participant nodes, wherein the source that is external to the video call comprises an application other than the communication application.

### Example 15

The method of Examples 9-14 wherein identifying the set of candidate moments comprises evaluating moments occurring on the video call based on rules that become increasingly selective as the video call extends in duration.

### Example 16

The method of Examples 9-15 wherein the method further comprises selecting the rules based on a context of the video call.

### Example 17

A computing apparatus comprising: one or more computer readable storage media; a processing system operatively coupled with the one or more computer readable storage media and; a montage service comprising program instructions stored on the one or more computer readable storage media that, when read and executed by the processing system, direct the processing system to at least: while a video call is ongoing between at least two participant nodes, identify a set of candidate moments to consider for representation in a montage of the video call and extract content from the video call for each of the candidate moments; after the video call has ended, select a subset of candidate moments from the set of candidate moments to represent in the montage and generate the montage from the content extracted from the video call for each of the subset of candidate moments; and send the montage to at least one of the participant nodes.

### Example 18

The computing apparatus of Example 17 wherein the video call comprises video streams exchanged between at least the two participant nodes and wherein to extract the content from the video call, the program instructions direct the processing system to extract the content from both streams of the video call for at least one moment of the candidate moments.

### Example 19

The computing apparatus of Examples 17-18 wherein the content extracted from the video streams for one candidate moment comprises an image or a clip of an action extracted from one of the video streams and another image or another clip of a reaction to the action extracted from another one of the video streams.

### Example 20

The computing apparatus of Examples 17-19 wherein, to identify the set of candidate moments, the program instructions direct the processing system to evaluate moments occurring on the video call based on rules that become increasingly selective as the video call extends in duration.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media and;
a montage service comprising program instructions stored on the one or more computer readable storage media that, when read and executed by the processing system, direct the processing system to at least:
while a video call is ongoing that comprises video streams exchanged between at least two participant nodes, identify a set of candidate moments to consider for representation in a montage of the video call and extract content for each of the set of candidate moments from both of the video streams;
generate the montage from at least the content extracted from the video call for the set of candidate moments; and
send the montage to at least one of the participant nodes.

2. The computing apparatus of claim 1 wherein the program instructions further direct the processing system to, after the video call has ended, select a subset of candidate moments from the set of candidate moments to represent in the montage, and wherein, to generate the montage for the set of candidate moments, the program instructions direct the processing system to generate the montage from the content extracted from the video call for each of the subset of candidate moments.

3. The computing apparatus of claim 1 wherein the content extracted from both of the video streams for each of the set of candidate moments comprises an image or a clip of an action extracted from one of the video streams and another image or another clip of a reaction to the action extracted from another one of the video streams.

4. The computing apparatus of claim 1 wherein the program instructions direct the processing system to, for at least one candidate moment of the set of candidate moments, identify external content from a source that is external to the video call, and include the external content in the montage.

5. The computing apparatus of claim 4 wherein each of the video streams originates from a video modality in a communication application on a respective one of the participant nodes, wherein the source that is external to the video call comprises a modality other than the video modality in the communication application.

6. The computing apparatus of claim 4 wherein each of the video streams originates from a video modality in a communication application on a respective one of the participant nodes, wherein the source that is external to the video call comprises an application other than the communication application.

7. The computing apparatus of claim 1 wherein, to identify the set of candidate moments, the program instructions direct the processing system to evaluate moments occurring on the video call based on rules that become increasingly selective as the video call extends in duration.

8. The computing apparatus of claim 7 wherein the program instructions direct the processing system to select the rules based on a context of the video call.

9. A method of operating a montage service comprising:
while a video call is ongoing that comprises video streams exchanged between at least two participant nodes, identifying a set of candidate moments to consider for representation in a montage of the video call and extracting content for each of the set of candidate moments from both of the video streams;
generating the montage from at least the content extracted from the video call for the set of candidate moments; and
sending the montage to at least one of the participant nodes.

10. The method of claim 9 further comprising:
after the video call has ended, selecting a subset of candidate moments from the set of candidate moments to represent in the montage; and
wherein generating the montage for the set of candidate moments comprises generating the montage from the content extracted from the video call for each of the subset of candidate moments.

11. The method of claim 9 wherein the content extracted from both of the video streams for each of the set of candidate moments comprises an image or a clip of an action extracted from one of the video streams and another image or another clip of a reaction to the action extracted from another one of the video streams.

12. The method of claim 9 wherein the method further comprises, for at least one candidate moment of the set of candidate moments, identifying external content from a source that is external to the video call, and including the external content in the montage.

13. The method of claim 12 wherein each of the video streams originates from a video modality in a communication application on a respective one of the participant nodes, wherein the source that is external to the video call comprises a modality other than the video modality in the communication application.

14. The method of claim 13 wherein each of the video streams originates from a video modality in a communication application on a respective one of the participant nodes, wherein the source that is external to the video call comprises an application other than the communication application.

15. The method of claim 9 wherein identifying the set of candidate moments comprises evaluating moments occurring on the video call based on rules that become increasingly selective as the video call extends in duration.

16. The method of claim 15 wherein the method further comprises selecting the rules based on a context of the video call.

17. A computing apparatus comprising:
one or more computer readable storage media;
a processing system operatively coupled with the one or more computer readable storage media and;
a montage service comprising program instructions stored on the one or more computer readable storage media that, when read and executed by the processing system, direct the processing system to at least:
while a video call is ongoing between at least two participant nodes, identify a set of candidate moments to consider for representation in a montage of the video call and extract content from the video call for each of the set of candidate moments;
after the video call has ended, select a subset of candidate moments from the set of candidate moments to represent in the montage and generate the montage from the content extracted from the video call for each of the subset of candidate moments; and
send the montage to at least one of the participant nodes.

18. The computing apparatus of claim 17 wherein the video call comprises video streams exchanged between at least the two participant nodes and wherein to extract the content from the video call, the program instructions direct the processing system to extract the content from both streams of the video call for at least one moment of the set of candidate moments.

19. The computing apparatus of claim 18 wherein the content extracted from the video streams for one candidate moment comprises an image or a clip of an action extracted from one of the video streams and another image or another clip of a reaction to the action extracted from another one of the video streams.

20. The computing apparatus of claim 17 wherein, to identify the set of candidate moments, the program instructions direct the processing system to evaluate moments occurring on the video call based on rules that become increasingly selective as the video call extends in duration.
